(19) United States
(12) Patent Application Publication
(10) Pub. No.: US 2010/0006352 A1
(43) Pub. Date: Jan. 14, 2010

(54) Cannon-shaped wind turbines for electric vehicles

(76) Inventor: Fabio Agostini, Wantagh, NY (US)

Correspondence Address: RICHARD B. KLAR, 145 WILLIS AVENUE, SUITE NO. 6, MINEOLA, NY, 11501, US

(21) Appl. No.: 12/459,920

(22) Filed: Jul. 9, 2009

Related U.S. Application Data
(60) Provisional application No. 61/134,532, filed on Jul. 11, 2008.

(51) Int. Cl. B60K 16/00; B60L 8/00; F03D 9/00; F03D 3/02

(52) U.S. Cl. 180/2.2; 290/55; 416/124

(57) ABSTRACT

A wind energy device is formed of one or more units. Each unit is formed of funnel or cannon-shaped receptacles for receiving wind are assembled in a pin-wheel fashion. The receptacles are formed as units. Each unit, which includes two cannon-shaped receptacles, is connected so as to be longitudinally aligned with slanted opening faces, preferably at a 45 degree angle, facing outward to receive wind therein and with two additional cannon-shaped receptacles located on each side face of the two aligned cannon-shaped receptacles preferably at the point where the two connect to each other.

### RELATED APPLICATIONS

This is a non-provisional application of a provisional application Ser. No. 61/134,532 by Fabio Agostini filed Jul. 11, 2008.

### BACKGROUND

1. Field

Wind powered engines provide an environmentally friendly, fuel alternative to the use of fossil fuels to power engines. Alternative energy provides for a cleaner, more efficient and safer environment while providing the necessary power for motor vehicles. Man has harnessed wind power for sailing with great success. It would be desirable to develop an effective system and device for harnessing wind power for engines to power automotive vehicles, houses, etc.

2. The Related Art

U.S. Pat. No. 2,704,130 (COX GEORGE R) shows a blade structure having a pair of diametrically oppositely disposed blades 10 and 11 that are twisted or pitched in a direction to propel air as the propeller rotates upon its axis.

US Patent Publication 2001/0011825 (de Vega, Dora Angelica Gericke) discloses a wind energy generator car with plural turbines on a rod.

### SUMMARY

Funnel or cannon-shaped receptacles for receiving wind are assembled in a pin-wheel fashion. The receptacles are formed as units.

Each unit, which includes two cannon-shaped receptacles, is connected so as to be longitudinally aligned with slanted opening faces, preferably at a 45 degree angle, facing outward to receive wind therein and with two additional cannon-shaped receptacles located on each side face of the two aligned cannon-shaped receptacles preferably at the point where the two connect to each other.

In this fashion, each unit has a receptacle opening spaced apart from the next respective one, a small determined distance so that as the wind enters one of the receptacles and causes it to rotate, the next receptacle is moved into position to receive the wind and so forth. In this way, the unit will constantly rotate with the wind entering each duct of the unit in turn.

There are preferably three units that are mounted on a hollow rectangular shaped tube and there are three units on each side of the tube preferably. The rotation of the cannon-shaped units will charge the engine, to which this device is connected, charging the battery.

### BRIEF DESCRIPTION OF THE DRAWINGS

FIG. 1 sectional view of an embodiment of the invention showing the wind energy device connected to an automobile;

FIG. 2 shows one unit with the connection to the rectangular shaped connecting tube;

FIG. 3 shows two units of the present invention connected together;

FIG. 4 shows another embodiment for the invention used with a truck; and

FIG. 5 shows another embodiment for the present invention used to power a house with wind energy.

### DETAILED DESCRIPTION FOR THE PREFERRED EMBODIMENT(S)

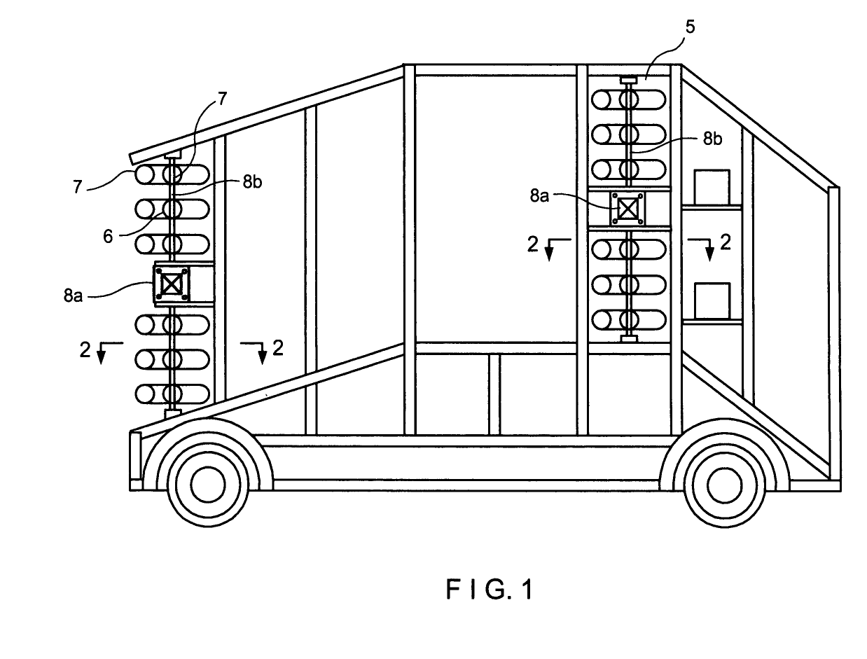

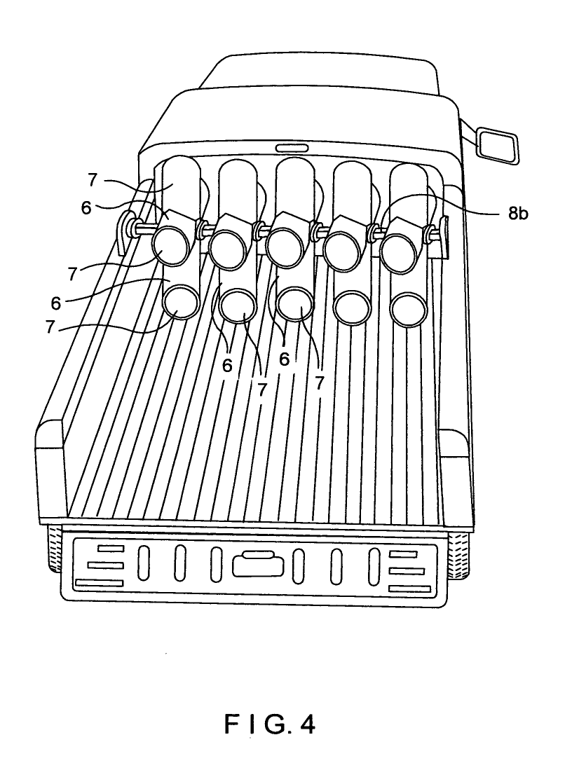

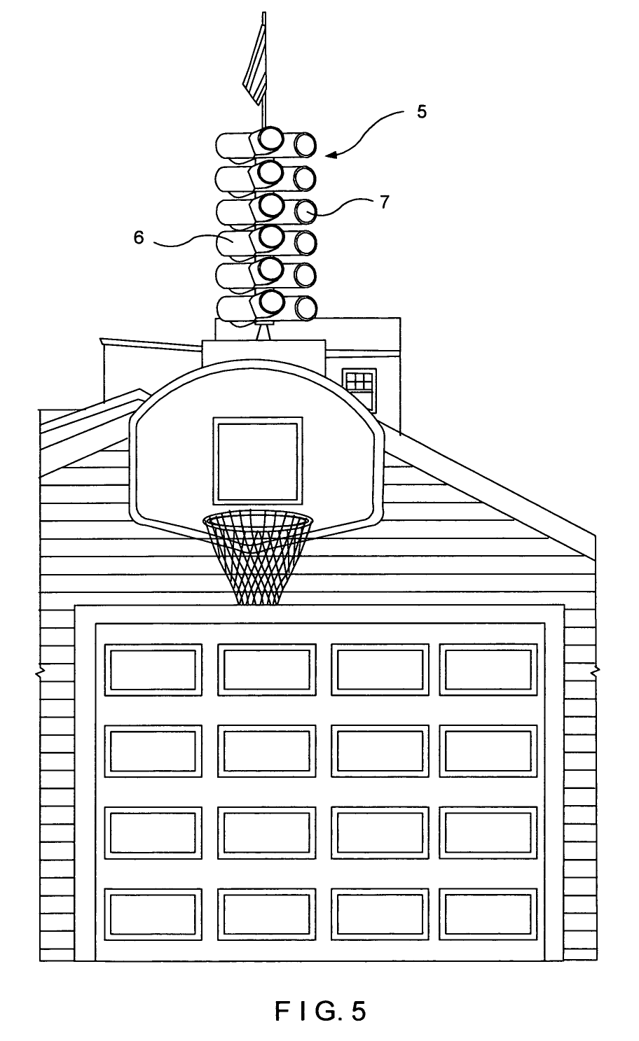

Referring to the drawings, FIG. 1 illustrates an embodiment of the present invention in which a wind energy device 5 of the present invention is used for powering an automobile engine with wind power. Each unit 10 is formed of two funnel or cannon-shaped receptacles 6. Each receptacle has one end having a slanted opening 7 with preferably a 45 degree slant to receive wind therein. The 45 degree angle serves to better provide for capturing wind that is near and can enter into each of the cannon receptacles 6 slanted openings. The two cannon receptacles 6 are connected to each at their opposite non-slanted opening ends preferably by screws, bolts and plates inside and outside the side surfaces of the two aligned receptacles (see FIG. 3) and are centered there and connected by a central connecting plate 8a and a preferably rectangular shaped hollow tube 8b (See FIGS. 1, 2, 3 and 4). The sides 9 of the cannon receptacles thus connected have another cannon receptacle 6 connected thereto on each of two sides 9 of the connected cannon receptacles 6 (again preferably by plates, screws and bolts). In this way, each of the side connected receptacles 6 also has a slanted opening 7 for capturing wind therein. In this way, each of the thus described units 10 has six slanted openings 7 and forms a pin wheel arrangement for receptacles 6 for capturing wind and turning so that every 6 inches or so another opening 7 is available during wind induced rotation for the unit 10 to receive wind therein. Preferably three units 10 are mounted on each of two sides 13 of the rectangular connecting tube 8. Tin material is preferably used for the cannon receptacles and aluminum for the connecting tube. The connecting tube is connected or coupled at each side to a generator (not shown)—by way of example a tube end may be connected to the input shaft of a generator (as described in U.S. Pat. No. 7,434,636) to charge the generator with electrical energy due to the rotation of the tube by the rotational movement of the wind cannon receptacles. Although this U.S. Pat. No. 7,434,636 describes the generator in the car this connection can also be used for a separate generator which will supply electricity to the car battery. The charged generator delivers the electrically energy to a battery such as the car battery for the embodiment in FIG. 1 where it is stored to provide electrical power to an automobile (FIG. 1), a truck (FIG. 4) or a house (FIG. 5). In FIG. 1 a standard generator can be used with an electrical wire connecting to a safety regulator switch which is in turn connected electrically to the car battery or alternatively to an extra battery.

FIG. 1 shows an embodiment for the present invention adapted for charging an automobile with wind energy captured by the six units shown on the device 5.

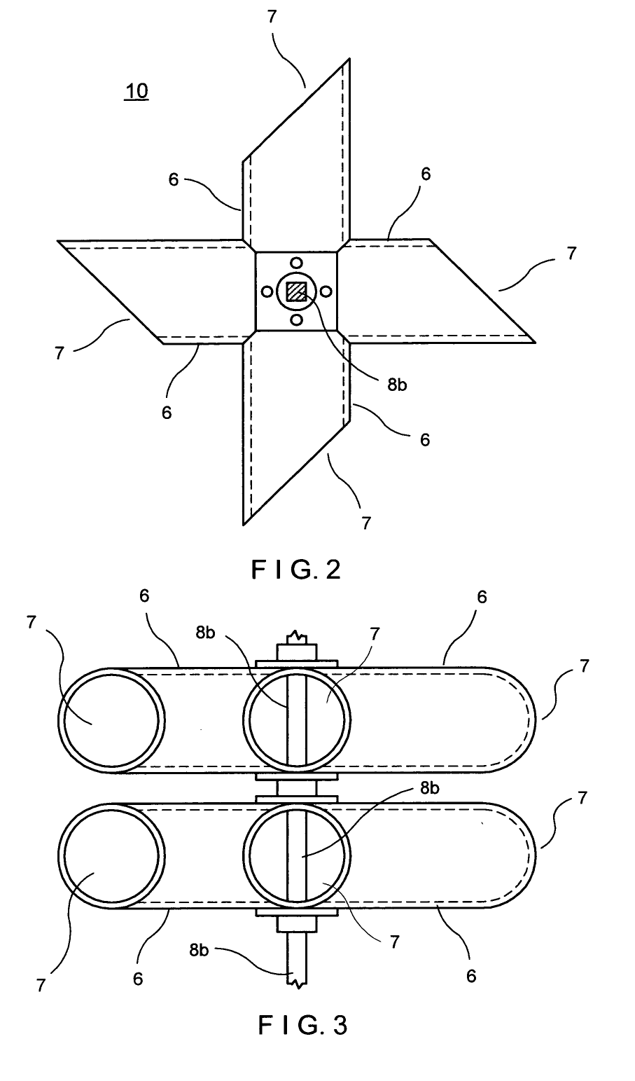

FIG. 2 is a sectional view illustrating one unit 10 and the two opposing cannon receptacles 6 connected to each other and the two side mounted cannon receptacles 6 and how the unit 10 is connected to the connecting plate 8a and connecting tube 8b.

FIG. 3 shows the units of FIG. 2 of the present invention connected together with the connecting plate 8a and tube 8b connecting the units 10, together. It is understood that any number of units 10 can be connected together in this fashion such as the six units 10 shown in FIG. 1.

FIG. 4 shows another embodiment for the present invention for charging a pick up truck's generator using the units 10 as shown. In FIG. 4, a standard generator can be connected or coupled to the connecting tube 8b and between the generator and the car battery a safety regulator switch can be connected there between. The generator used for the embodiment for FIG. 4 can be by way of non-illustrative example alternator products sold by Motor Craft and generators used by Ford trucks.

FIG. 5 shows another embodiment in which the units 10 are mounted on top of a house and provide wind power energy for the house. The wind energy device 5 can charge a home generator. In FIG. 5 a regulator safety switch is connected to the generator and the battery or power storage unit for the house.

While certain embodiments have been shown and described, it is distinctly understood that the invention is not limited thereto but may be otherwise embodied within the scope of the appended claims.

What is claimed:

1. A wind energy device comprising:
one or more units formed of funnel or cannon-shaped receptacles for receiving wind including two cannon-shaped receptacles connected to each other so as to be longitudinally aligned with slanted opening faces facing outward to receive wind therein and with two additional cannon-shaped receptacles located on each side surface of said two aligned cannon-shaped receptacles at a point where the two longitudinally aligned receptacles are connected to each other.

2. The device according to claim 1 wherein said slanted opening is preferably at a 45 degree angle.

3. The device according to claim 1 wherein six units are connected together with three units being located on each of two sides of a connecting tube, said connecting tube having a connecting plate centered between both sides of said tube wherein said connecting tube and said connecting plate connects said units together, so that the units rotate together when wind enters any one or more of the cannon-shaped receptacles.

4. The device according to claim 1 wherein said device is used for an automobile.

5. The device according to claim 1 wherein said device is mounted on a roof of a house and used to provide energy to charge a generator for a house.

6. The device according to claim 1 wherein said cannon-shaped receptacles are made of tin.

7. The device according to claim 1 wherein said connecting tube is hollow and rectangular shaped.
